(19) United States
(12) Patent Application Publication
(10) Pub. No.: US 2010/0049373 A1
(43) Pub. Date: Feb. 25, 2010

(54) METHOD FOR MODULAR SOFTWARE REMOVAL

(75) Inventors: THOMAS M. P. CATSBURG, Rochester, MI (US); Ansaf I. Alrabady, Livonia, MI (US)

Correspondence Address: INGRASSIA FISHER & LORENZ, P.C. (GM), 7010 E. COCHISE ROAD, SCOTTSDALE, AZ, 85253, US

(73) Assignee: GM GLOBAL TECHNOLOGY OPERATIONS, INC., DETROIT, MI (US)

(21) Appl. No.: 12/197,550

(22) Filed: Aug. 25, 2008

(51) Int. Cl. G06F 9/44; G06F 17/00

(52) U.S. Cl. 701/1; 717/120

(57) ABSTRACT

A method of managing a code module that generates output information for a computer system is provided. The method comprises searching for the output information in the computer system, if the output information is not detected by the searching step, executing the code module, generating the output information in response to executing the code module, and removing the code module from the computer system in response to generating the output information.

### TECHNICAL FIELD

Embodiments of the subject matter described herein relate generally to software module management. More particularly, embodiments of the subject matter relate to post-execution software removal.

### BACKGROUND

Certain software instructions can contain algorithms which are themselves proprietary, secret, or confidential, even while the output of the algorithms is not. This can be particularly problematic where the memory module containing the software instructions is provided to untrusted parties as part of transfer of the system containing the output information. For example, a proprietary method of producing a checksum can be implemented in software. The resulting checksum can be useful to checking certain features of a system or object containing the system. Preferably, however, the method of formulation of the checksum should remain undisclosed to inhibit counterfeiting or falsification of checksums. It can be difficult to generate the checksum without providing the method of generation to the computer system storing the checksum.

Similarly, cryptographic instructions can sometimes be used in a computer system to produce a key pair for use with secure data communication. For various reasons, it is sometimes advantageous to generate the key pair without disclosing the algorithm or instruction set which generated the key pair. Thus, it would be advantageous to provide a computer system which produced the result of the software instructions without revealing the software instructions.

### BRIEF SUMMARY

A method of managing a code module that generates output information for a computer system is provided. The method comprises searching for the output information in the computer system, if the output information is not detected by the searching step, executing the code module, generating the output information in response to executing the code module, and removing the code module from the computer system in response to generating the output information.

A method of managing a code module that is adapted to generate output information for a vehicle-based computer system is also provided. The method comprises searching for the code module in the computer system, executing the code module if the searching step detects the code module, generating output information in response to executing the code module, and thereafter removing the code module from the computer system.

A method of operating an onboard computer system for a vehicle is also provided. The method comprises executing a code module of the computer system to produce output information specific to the vehicle, confirming the existence of the output information in the computer system, and removing the code module from the computer system after confirming the existence of the output information.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a schematic illustration of a computer system; and

FIG. 2 is a diagram of an embodiment of a method for removing an executed code module.

### DETAILED DESCRIPTION

The following detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, brief summary or the following detailed description.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. Moreover, the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

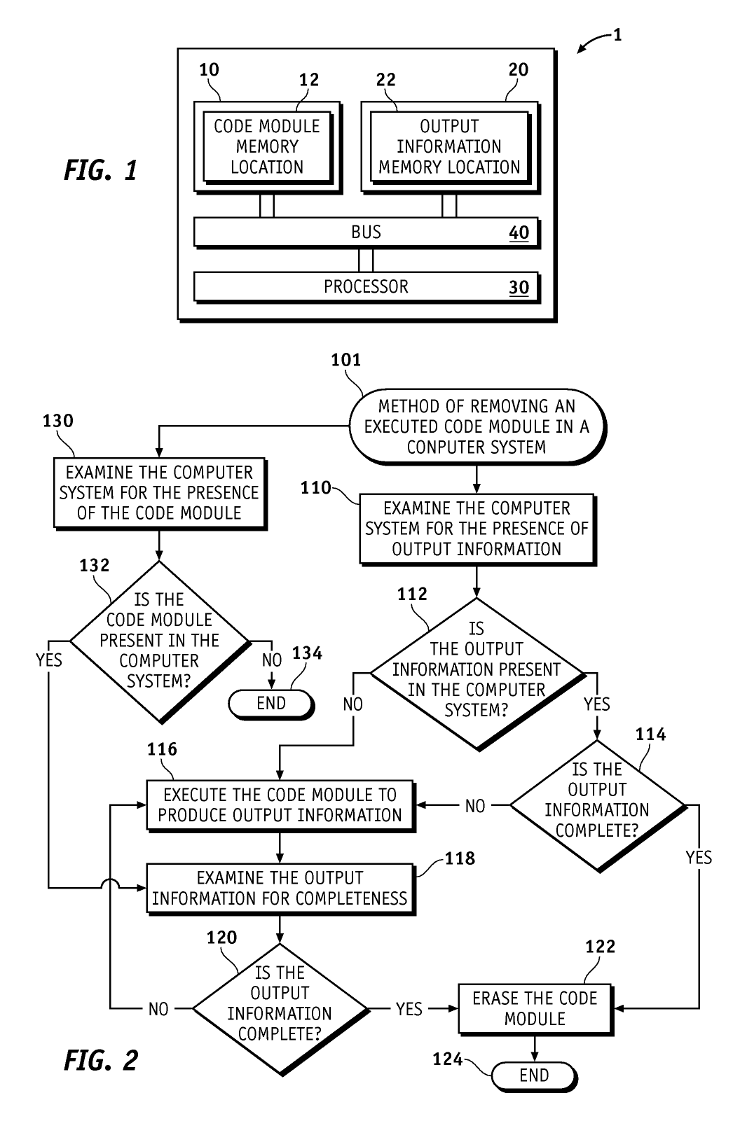

FIG. 1 illustrates an embodiment of a computer system 1 comprising a first memory module 10, a second memory module 20, a processor 30, and a bus 40 coupling the components. A practical implementation of computer system 1 may also have additional hardware, firmware, and/or software elements that support conventional functions and operations. For the sake of brevity, conventional aspects of computer architectures, encryption, computer programming, and other functional aspects of computer system 1 (and the individual operating components of the computer system 1) may not be described in detail herein.

The first memory module 10 can contain a code module at a code module memory location 12. Similarly, the second memory module 20 can, as explained below, contain an output information memory location 22. The bus 40 can permit the processor 30 and memory modules 10, 20 to exchange information. Preferably, the code module stored in the code module memory location 12 is executed, producing output information stored in the output information memory location 22. Following execution of the code module, it is erased (i.e. deleted and removed) from the code module memory location 12, as described in more detail below. The removal of the code module can immediately follow execution, or can result after a search for, and successful detection of, the desired output information. In some embodiments, the output information can be evaluated for completeness and/or authenticity prior to removal of the code module. If necessary, the code module can be run multiple times prior to its removal.

The code module stored in the code module memory location 12 is preferably a modular software segment capable of being executed by the processor 30. The code module can be embodied in any appropriate language or instruction set for use in the system 1 with the illustrated processor 30, or multiple processors, if appropriate to the embodied system. Because of the modularity of the code module, other code modules (not shown) stored in the depicted memory modules or elsewhere in the system 1 can call or invoke the code module, or, if the code module has been removed, execution of other code modules can continue without disruption to the system.

The output information stored in the output information memory location 22 can be any type of information generated by the code module and useful to the system 1. As one example, for code modules comprising cryptographic algorithms, the corresponding output information can be a key pair useful for securely communicating with other computer systems.

Frequently, the computer system 1 is embodied or embedded in a larger system for use in controlling or operating components or processes of the larger system. One such application for the computer system 1 can be a vehicle. Where the computer system 1 is disposed in a vehicle, certain aspects of the vehicle's information, such as a manifest containing subcomponent serial number information, or other vehicle-identifying information can be embodied as the output information. As another example, unique or identifying authenticity information can comprise the output information. Likewise, the initial odometer reading of a vehicle can comprise the output information, together with other information, if desired in the embodiment. As another example, the code module can generate calibration information for various components of the vehicle, and that calibration information can be stored and by the computer system. Thereafter, removal of the code module can be performed to render the calibration unalterable. Fixing calibration information can be useful for reducing the likelihood that user intervention can alter the vehicle to an undesirable or sub-optimal state. Combinations of these examples are also contemplated.

Although the first and second memory modules 10, 20 are illustrated and described as discrete elements, a single memory module can contain both the code module memory location 12 and the output information memory location 22 if so desired. Further, the first and second memory modules 10, 20 can be subcomponents of a large memory device or module in certain embodiments. Thus, although drawn separately for illustrative purposes, the artificial division between memory modules need not be so embodied. Similarly, although the bus 40 is only illustrated as connecting certain components, other components also can be a part of the computer system 1, as desired.

While reference is made to a code module stored at a certain memory location 12, the algorithm, instructions, or other information comprising the code module are not restricted to code specifically, such as object code or machine code, but can be instructions of any sort appropriate to the computer system 1. Thus, the instructions can be in any processor- or system-suitable language, format, type and/or size appropriate for the embodiment. Similarly, the output information disposed in the output information memory location 22 can be any useful or desired set of information. Thus, although certain types, including cryptographic information, symmetric and asymmetric key pairs, calibration information, authenticity information, and odometer information are disclosed, others are contemplated, such as manifest information listing components of the vehicle or other object in which the computer system is embodied.

Operation of the system 1 is described in concert with use of the method or process 101 illustrated in FIG. 2. The various tasks performed in connection with method 101 may be performed by software, hardware, firmware, or any combination thereof. For illustrative purposes, the following description of method 101 may refer to elements mentioned above in connection with FIG. 1. In practice, portions of process 101 may be performed by different elements of the described system, e.g., the memory modules 10, 20, processor 30, or bus 40. It should be appreciated that method 101 may include any number of additional or alternative tasks, the tasks shown in FIG. 2 need not be performed in the illustrated order, and method 101 may be incorporated into a more comprehensive procedure or method having additional functionality not described in detail herein.

The computer system 1, in response to instructions, can examine or search (task 110) its file system or other memory storage mechanism for the presence of certain output information stored at the output information memory location 22. Such a check can be made upon every activation of the system 1, periodically based on time or activation intervals, or prompted through a user interface, depending on the embodiment. Detection of the output information can be an indicator that the code module has been successfully executed and should be removed from the system if it has not been already. Additionally, in some embodiments, the output information can be examined to determined that it is complete prior to removal of the code module from the system.

After the search or examination, the method 101 can determine whether or not the desired output information is present (task 112) in the computer system. In the event that the output information is not detected during examination, the computer system 1, by way of the processor 30, can execute (task 116) the code module, thereby generating the desired output information. Execution of the code module produces the output information, which is preferably stored at the output information memory location 22.

Subsequent to execution (task 116) of the code module, the output information memory location 22 is preferably examined (task 118) to determine whether or not the particular output information is complete. Completeness of the output information can be an indicator that the code module was successfully executed by the processor 30. Complete output information can be confirmed by a checksum, or examination of the information itself. For example, where a sequence of sixty-four 32-bit units of information is expected, completeness can be confirmed by checking for the existence of a flag indicative of complete and successful execution, a counter indicating the number of complete units, and/or a null-terminated sequence. Additionally, each unit can be inspected to verify that each is actually 32-bits in size. Incomplete output information can result from premature deactivation of the computer system 1, among other causes.

If the output information is determined (task 120) to be incomplete, the code module can be re-executed (task 116), and the output information subsequently re-examined (task 1 18). The loop defined by tasks 116, 118, and 120 may be repeated until the output information is verified to be complete, or until the method 101 times out. Following confirmation (task 120) that the output information is complete, the code module is removed (task 122).

Removal of the code module from the code module memory location 12 can be done as desired or appropriate for the system. Removing the code module corresponds to erasing the code module, whether by deleting it, uninstalling it, reformatting or overwriting the memory location of the code module, magnetic wiping, or any other procedure sufficient to clear the code module from the computer system. Preferably, the removal of the code module is unrecoverable; however, certain embodiments can erase, delete, and/or remove the code module in such a manner that it can be recovered.

Thus, in certain embodiments, “removing the code module” can be embodied as deleting a computer system file containing the code module and/or the code module instructions. In certain embodiments, particularly those where the memory module 10 is embodied as flash memory, the memory can be reflashed from another source to overwrite the code module. Such overwriting can result in a previously-designated default memory pattern being written over the code module at the code module memory location 12. Overwriting the memory location of the code module can be done to prevent post-deletion recovery of the code module.

As mentioned, in certain embodiments, removing the code module can comprise overwriting the code module memory location 12. Such overwriting can be accomplished by writing a pattern or random sequence of information to the memory module 10 at the address or location corresponding to the code module memory location 12. Furthermore, overwriting the code module memory location 12 can be performed one time, or multiple times, without limit, as specific to the computer system 1, specified by the user, or through other designation. Moreover, multiple removal methods can sometimes be embodied in the same removal procedure, such as deleting the file containing the code module, reflashing the memory module 10, and subsequently overwriting the code module memory location 12 multiple times with random bit information.

In some embodiments, the computer system 1 can execute additional instructions prior to removing the code module memory location 12. Such execution can result in a preliminary examination of the code module memory location 12. In the event that a certain removal pattern is present, the system 1 can omit the step of removal, if desired. In some embodiments, however, no such check is performed, and the code module memory location 12 can be deleted or overwritten or otherwise erased repeatedly, each time an examination of the computer system for the output information is performed.

In certain embodiments, after detection of complete output information (task 120), the system 1 can, together with removal of the code module (task 122), or separately therefrom, further eliminate the instructions which cause the search for the output information, thereby reducing the number of steps performed during startup or normal operation. Removal of the code module following detection of complete output information can be the final step 124 of the method 101.

In the event that the desired output information is detected (task 112) at the output information memory location 22, it is preferably examined to determine (task 114) completeness, as described above. If task 114 determines that the output information is incomplete, then the method 101 may proceed to task 116, and continue in the manner described above. Where the output information is determined to be complete, however, removal (task 122) of the code module can follow, using any of the techniques and methodologies described previously, including a combination thereof.

Some embodiments may take an alternate approach for the method 101. In such alternate embodiments, the computer system 1 can examine (task 130) the file system for the presence of the code module itself, which can be stored at the code module memory location 12. Detection of the presence of the code module at the code module memory location 12 can indicate that the code module has not yet been successfully executed, because otherwise, it would have been removed from the computer system 1 (as explained above).

Thus, instead of searching for the output information, the computer system 1 can be examined (task 130) to determine (task 132) whether the code module itself is present. If the code module is not present, the method 101 can terminate (task 134). In the event the code module is found, the output information memory location 22 can be examined (task 118) for completeness of the output information, as described above, and with subsequent steps as described above. A lack of output information can be considered as incomplete output information during determination (task 120) of its completion.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A method of managing a code module that generates output information for a computer system, the method comprising:
searching for the output information in the computer system;
if the output information is not detected by the searching step, executing the code module;
generating the output information in response to executing the code module; and
removing the code module from the computer system in response to generating the output information.

2. The method of claim 1, wherein the output information comprises cryptographic key information and the code module creates cryptographic information.

3. The method of claim 2, wherein the cryptographic information comprises key pair information.

4. The method of claim 1, wherein the computer system is disposed in a vehicle.

5. The method of claim 4, wherein the output information comprises calibration information used to operate the vehicle.

6. The method of claim 4, wherein the output information comprises authenticity information used to identify a component of the vehicle.

7. The method of claim 4, wherein the output information comprises odometer information for the vehicle.

8. The method of claim 1, wherein removing the code module comprises deleting a file corresponding to the code module.

9. The method of claim 1, wherein removing the code module comprises reflashing a memory address corresponding to the memory location of the code module.

10. A method of managing a code module that is adapted to generate output information for a vehicle-based computer system, the method comprising:
searching for the code module in the computer system;
executing the code module if the searching step detects the code module;
generating output information in response to executing the code module; and
thereafter removing the code module from the computer system.

11. The method of claim 10, further comprising examining the output information for completeness prior to removing the code module.

12. The method of claim 11, further comprising re-executing the code module if the examining step detects incomplete output information.

13. The method of claim 12, further comprising re-examining the output information for completeness after re-executing the code module.

14. The method of claim 10, further comprising searching for the output information after executing the code module.

15. The method of claim 10, wherein removing the code module from the computer system comprises detecting a location of the code module in a file system.

16. The method of claim 15, wherein removing the code module from the computer system further comprises overwriting the file system in the location of the code module.

17. The method of claim 16, wherein overwriting the file system in the location of the code module comprises overwriting the location with a bit pattern more than once, thereby inhibiting recovery of the code module.

18. A method of operating an onboard computer system for a vehicle, the method comprising:
executing a code module of the computer system to produce output information specific to the vehicle;
confirming the existence of the output information in the computer system; and
removing the code module from the computer system after confirming the existence of the output information.

19. The method of claim 18, further comprising examining the output information for completeness prior to removing the code module.

20. The method of claim 19, wherein
examining the output information results in determination of incomplete output information; and
the method further comprises re-executing the code module in response to the determination of incomplete output information.
